(19) United States
(12) Patent Application Publication
(10) Pub. No.: US 2014/0108953 A1
(43) Pub. Date: Apr. 17, 2014

(54) SYSTEMS AND METHODS FOR SELECTING COLORED FILMS AND DESIGNING LAYOUTS

(71) Applicant: 3form, Salt Lake City, UT (US)

(72) Inventors: Jonathan Greene, Salt Lake City, UT (US); Ben Newbold, Murray, UT (US); Shaine Hatch, Salt Lake City, UT (US)

(73) Assignee: 3form, Salt Lake City, UT (US)

(21) Appl. No.: 14/053,461

(22) Filed: Oct. 14, 2013

Related U.S. Application Data
(60) Provisional application No. 61/714,110, filed on Oct. 15, 2012.

(51) Int. Cl. G06F 3/0484

(52) U.S. Cl. CPC G06F 3/04842; G06F 3/04847
USPC 715/747

(57) ABSTRACT

A method for allowing a designer to create a customized panel wall system includes displaying on a computer monitor one or more customization options for a panel wall design. The method can also include receiving designer input specifying the one or more customization options for the panel wall design. The designer input can include a particular color for the panel wall design. The method can include identifying the particular color selected by the designer. The method can also include determining a matching color that most closely recreates the particular color by combining together one or more colors from a pre-determined list of available discrete colors. After determining the matching color, the method can include displaying to a designer a digital depiction of the panel wall design.

### CROSS-REFERENCE TO RELATED APPLICATIONS

The present application claims the benefit of and priority to U.S. Provisional Patent Application No. 61/714,110, entitled, “Systems and Methods for Selecting Colored Films and Designing Layouts” filed Oct. 15, 2012, the entire content of which is incorporated herein by reference.

### BACKGROUND OF THE INVENTION

1. Technical Field

The present disclosure relates generally to software for use in architectural design.

2. Background and Relevant Art

With increasing regularity in recent years, architectural designers, along with residential, commercial, and industrial construction workers, have been incorporating pre-manufactured panels into buildings and homes. For example, pre-manufactured panels can be used for building walls, ceilings, dividers, as treatments thereof, and for other similar construction features. Pre-manufactured panels provide many benefits including, but not limited to, the ability to quickly install the panels, the ability to create design features that include three-dimensional elements, and the general durability of the pre-manufactured panels.

An additional benefit of the pre-manufactured panels is the great variety of colors, materials, and textures that the panels can provide. In many cases, when using these panels, designers prefer to specify particular materials from which the panels are made and specific colors for the panels. In response to a designer's request, pre-manufactured panels can be selected that most closely match the designer's request, or custom panels can be manufactured. When custom manufacturing panels to meet a designer's customization, the resulting colors and materials can still be limited by the colors and materials that the panel manufacturer uses in its processes. Additionally, in some situations, a manufactured may have to utilize additional material, such as additional colored films, to designers requested specifications, resulting in more costly panels.

Also, whether custom manufacturing panels or manufacturing an order of standard, non-customized panels for a designer, excess panels may be created that result in waste. For instance, in some manufacturing processes, panels are manufactured in set batch sizes, such that if a designer orders a particular type of panel but does not order an entire batch or in multiples of an entire batch a portion of the manufactured batch will be wasted. Further, in some cases, a designer will be charged for the entire batch, even if they do not use all of the panels within the batch.

Accordingly, there are a number of disadvantages in the art that can be addressed relevant to manufacturing colored panels in a cost efficient and accurate way.

### BRIEF SUMMARY OF THE INVENTION

Implementations of the present invention overcome one or more problems in the art with systems, methods, and computer program products configured to enable designers to efficiently and easily select custom colors for panel wall systems through a computerized interface, and without the need for additional human intervention to independently coordinate (e.g., by another designer at the manufacturer) combinations of films or dyes. Furthermore, implementations of the invention can minimize production waste by automatically providing to the end designer information relevant to the most cost-effective production of the materials selected, thereby enabling the designer to save costs, or otherwise maximize usage of the materials needed to satisfy the designer's order.

For example, at least one implementation of the present invention includes a method for displaying on a computer monitor one or more customization options for a panel wall design. The panel wall design can comprise a plurality of independent panels joined together to form a wall. The method can also include receiving designer input specifying the one or more customization options for the panel wall design. The designer input can include a particular color for the panel wall design. The method can include identifying the particular color selected by the designer. Identifying the particular color can comprise determining a representation of the color within a color model. Additionally, the method can include determining a matching color that most closely recreates the particular color by combining together one or more colors from a pre-determined list of available discrete colors. Further, the method can include displaying to a designer a digital depiction of the panel wall design. The displayed panel wall design can comprise the one or more customization options specified by the designer input.

Another example of at least one implementation of the present invention includes a computerized system in a computerized panel wall design environment. In this implementation, the computerized system can display a panel wall design environment. The panel wall design environment can allow a designer to create and customize one or more independent panels joined together to form a panel wall design. The system can also receive a designer input specifying one or more characteristics of the panel wall design. Additionally, the system can display to the designer a digital depiction of the panel wall design. The displayed panel wall design can comprise one or more independent panels and the specified one or more characteristics. In at least one implementation, the system can also calculate a number of individual panels required to manufacture the displayed panel wall design. Further, the system can calculate a cost associated with manufacturing the panel wall design based upon the number of individual panels and the one or more characteristics of the one or more panels. The calculated cost can account for the number of individual panels that can be created in a batch. Further still, the system can display to the designer information relating to the cost of manufacturing the panel wall design.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated, in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an architectural schematic diagram of a system for creating a customized panel wall in accordance with an implementation of the present invention;

FIG. 2 illustrates a computer display showing a panel wall design system, including customization options in accordance with an implementation of the present invention;

FIG. 3 illustrates another computer display showing a color matching interface in accordance with an implementation of the present invention;

FIG. 4 illustrates a panel display system including a depicted panel wall in accordance with an implementation of the present invention;

FIG. 5 illustrates the panel display system of FIG. 4, wherein the depicted wall has been further customized in accordance with an implementation of the present invention;

FIG. 6 illustrates a computer display showing an implementation of the present system for creating a wovin type wall;

FIG. 7 illustrates a computer display showing an implementation of the present system for creating a wave type wall;

FIG. 8 illustrates a computer display showing an implementation of the present system for creating a ripple type wall;

FIG. 9 illustrates a computer display showing an implementation of the present system for creating a profile type wall;

FIG. 10 illustrates a computer display showing a cost optimization tool in accordance with an implementation of the present invention;

FIG. 11 illustrates a computer display showing a cost quotation tool in accordance with an implementation of the present invention;

FIG. 12 illustrates a flowchart of a series of acts in a method in accordance with an implementation of the present invention for creating a panel wall design; and

FIG. 13 illustrates a flowchart of a series of acts in another method in accordance with another implementation of the present invention for creating a panel wall design.

### DETAILED DESCRIPTION OF EMBODIMENTS

The present invention extends to systems, methods, and computer program products configured to enable designers to efficiently and easily select custom colors for panel wall systems through a computerized interface, and without the need for additional human intervention to independently coordinate (e.g., by another designer at the manufacturer) combinations of films or dyes. Furthermore, implementations of the invention can minimize production waste by automatically providing to the end designer information relevant to the most cost-effective production of the materials selected, thereby enabling the designer to save costs, or otherwise maximize usage of the materials needed to satisfy the designer's order.

Such implementations provide designers with a high degree of freedom in a CAD design environment comparable to the freedom available in conventional customized design approaches. Meanwhile, they also assure product availability and offer speed and cost savings typically associated with designs based on pre-manufactured materials. Furthermore, implementations of the current invention enable designers to save materials and cost by helping designers to optimize designs based on the manufacturing materials and processes of the particular panels used.

In one or more implementations, the design system can be implemented as a web-based tool. In such an implementation, the data and software supporting the system can be hosted on a server and in remote communication through the Internet with the web-based designer interface. In additional or alternative embodiments, the design system can be implemented as standalone applications installed on designers' personal computers or tablet computing devices.

In one or more implementations of the invention, different templates can present different categories of panels and panels to designers for selection and customization. In one or more implementations, panels may also be referred to as tiles. Common modules can then receive data collected in the panel selection and customization templates for designing, cost optimizing, saving and loading designs, requesting price quotes, and/or ordering products.

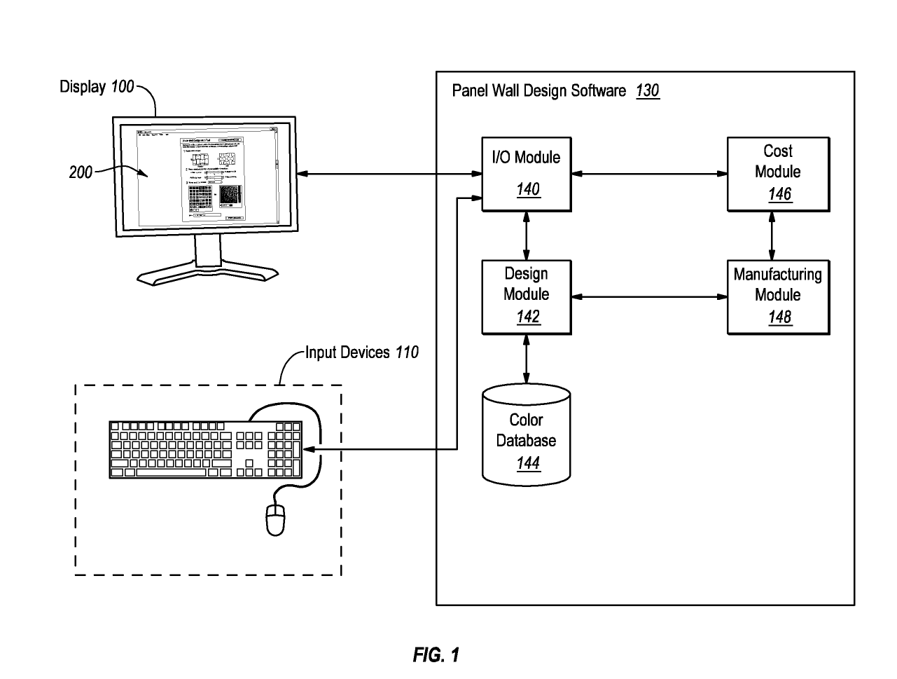

For example, FIG. 1 depicts an architectural schematic of a system for designing and customizing a panel wall design. The depicted system includes a display device 100 and one or more input devices 110 that can display information to a designer and receive designer input, respectively. The display device 100 and the one or more input device 110 are in communication with panel wall design software 130.

The panel wall design software 130 can be executed on a computer processor to provide a designer with a panel wall design environment 200. In at least one implementation, the panel wall design software is executed locally on the designer's computer, while in other implementations; the panel wall design software is executed on a remote server. Once executed, the display device 100 and the input devices 110 both communicate with I/O module 140. The I/O module 140 can direct the display device 100 to show various aspects of the panel wall design environment 200 and can receive instructions and commands from a designer through the input devices 110.

When receiving inputs from a designer, the I/O module 140 can communicate relevant commands to a design module 142. As such, the design module 142 can provide a designer with a variety of different design options, including, but not limited to, color options, material options, size options, and shape options. Once a designer selects a particular option, the design module 142 can provide the input to a manufacturing module 148, which automatically calculates all necessary panel wall parameters in response to the designer's commands, and provides the design module 142 with sufficient information to display a depiction of a panel wall design that conforms with the designer's commands.

For example, the design module 142 can receive instructions from a designer relating to a particular color that a designer wants incorporated into a panel wall design. Upon receiving the particular color, the design module 142 communicates with a color database 144 that contains pre-calculated information relating to the possible colors and color combinations that are available. Once a color match, or a set of similar colors, is identified, the design module 142 can either automatically select a color, or it can provide the color match or set of similar colors to the I/O module 140 for further designer input. The selected color can then be incorporated into the panel wall design.

Once a designer is satisfied with a panel wall design, the designer can access functions of a cost module 146. In at least one implementation, before a predicted price of the panel wall design is determined, the cost module 146 can provide the designer with information for reducing the cost of the panel wall design, or optimizing the amount spent on the wall. For example, in at least one implementation, a manufacturer creates individual panels for a panel wall in set batch sizes such that the cost for manufacturing a panel is determined at least in part by the number of batches that must be manufactured and not necessarily by the number of individual panels that must be manufactured. For instance, if a manufacturer creates ten individual panels in a given batch, then the price to manufacture a single panel may not be substantially more, if at all, than the price of manufacturing ten panels. Accordingly, in at least one implementation, the cost module 146, relying upon the manufacturing module 148, identifies to a designer cases where additional panels could be added to a panel wall design for minimum cost, due to unutilized panels from batches that must already be manufactured. Similarly, the cost module 146 can identify to a designer cases where removing a small number of panels from a panel wall design would result in eliminating one or more batch of panels from manufacture.

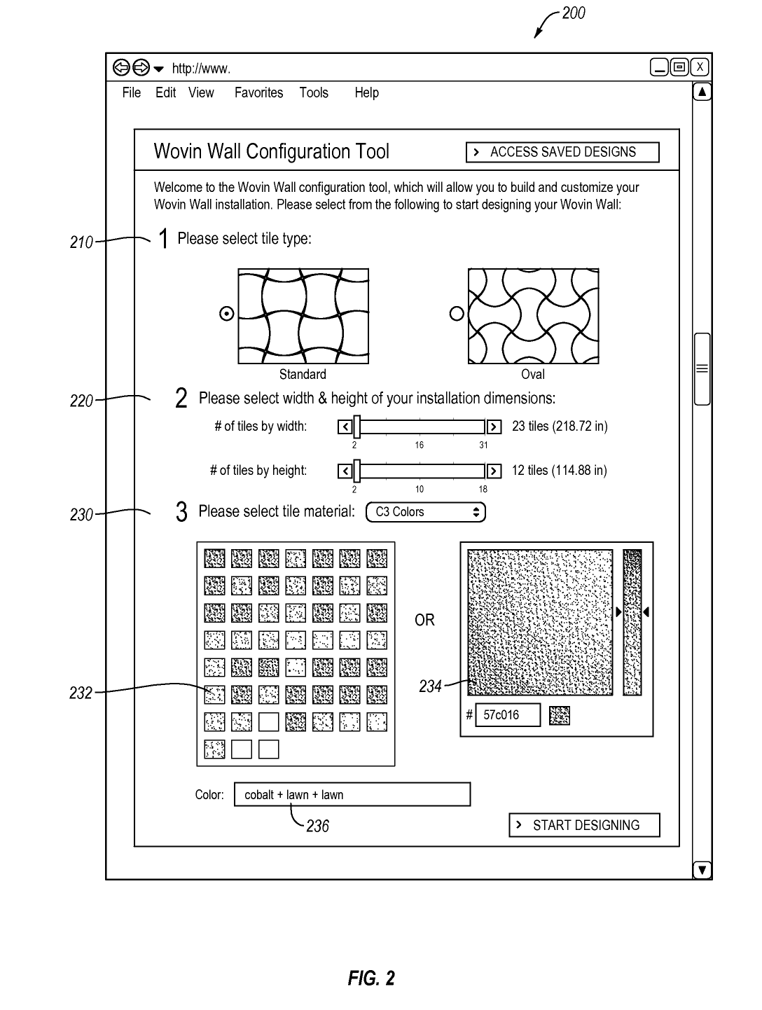

FIG. 2 shows an illustration of an implementation of a panel wall design environment 200. In at least one implementation, a designer starts a design process by selecting a particular panel type 210. Different panel selections and customization options can allow the designer to select and customize different categories of panels available from the manufacturer. In this implementation, for instance, the Wovin Wall panel selection and customization template shows graphic representations of various types of panels under the Wovin Wall category.

As shown in FIG. 2, the designer can choose a desired type of panel for a specific design. In the example shown here, a “Standard” type of Wovin Wall is selected. The I/O module 140 can display information about various types of panels on screen, as in the example here with graphical representations of the available types of panels. Alternatively or additionally, pop-up windows can display information about the panels when activated by mouse hovering over or right click.

After a selection is made, information relevant to the selection propagates to the design module 142. For instance, after receiving the designer input of “Standard” panel type, the I/O module 140 can send size information of the Standard panel to the design module 142 to guide the setup of installation dimensions. The I/O module 140 can also show additional customization options that allow a designer to further customize other properties of the panels.

FIG. 2 also shows that in one implementation of the panel wall design environment 200 the designer can define the dimensions of the panel work installation by adjusting horizontal sliders 220 representing the number of panels for the width and height of the installation. The manufacturing module 148 can then automatically calculate the width and height in distance units such as inches and centimeters based on the number of panels of the selected type. In an alternative implementation not shown here, it is possible to enter the desired dimensions in distance units. The manufacturing module 148 can calculate and display the number of panels needed, automatically adjusting the dimensions so that they are achievable by integer numbers of panels.

FIG. 2 also shows that in one implementation of the panel wall design environment 200 a panel selection option 230 is provided. Using the panel selection option 230, the designer can choose a panel material from a list of different materials. Depending on the particular material selected, further options for the material can be presented for designer selection. For example, the designer may also be provided with a color option. In at least one implementation, the available color options are determined by the manufacturing capabilities of the manufacturer. For instance, the manufacturer may utilize particular coloring materials based upon available color films, liquid dyes, solid colorants, pigments, and other manufacturing coloring materials.

Though the actual manufacturable colors may be limited, in at least one implementation, a designer is provided with options for creating customized colors beyond those depicted in the color swatch 232. In particular, a designer can create a custom color by mixing the colors depicted in the swatch 236. For example, FIG. 2 depicts a color selection indicator 236 showing that a designer has selected to mix the colors cobalt, lawn, and lawn (i.e., to deepen the “lawn” color with multiple selections thereof). In the case that colored films are used in the manufacturing process, this combination would be created by layering two lawn colored films with a single cobalt film.

In addition to selecting a combination of provided colors within the color swatch 232, in at least one implementation, a designer can select a color from a color pallet 234. Using the color pallet 234, a designer may be able to create virtually any possible color. Similarly, a designer may be able to create a custom color by using actual digital color values, such as RGB values, by uploading a specific color that the designer wishes matched (e.g., a paint chip), or through any other method for providing a system with a desired color. In each case, the I/O module 140 can display to the designer the custom color.

Once a color is selected, the design module 142 automatically determines, based upon the colors that are available to the manufacturer, what available color, or combination of available colors, most closely matches the custom color created by the designer. For example, in the case of color films, the design module 142 determines that a particular combination of the available color films will replicate the custom color. In this description, when discussing colors and color combinations, color films will be used in exemplary terms for the sake of simplicity and clarity; however, one will understand that similar color matching can be performed with liquid dyes, colorants, and any other set of combinable or mixable color substances.

In at least one implementation, the design module 142 can determine that four layers of color films, lemon+rust+rust+rain (i.e., using two rust films along with a single lemon film and a single rain film), can be used to generate a color that approximates the custom color. Additionally, in at least one implementation, if a designer desires to have a precise match, or a closer match, between the custom color and the manufacturable color, the design module 142 provides the option to achieve a closer match by using a larger number of color films. In this case, the manufacturing module 148 advises the designer of the additional costs associated with the additional materials and processes. In one or more embodiments, the design module 142 can use fewer than three layers of color films. In such embodiments, one or two layers of films may be sufficient to synthesize a particular color, while also potentially being less expensive to produce than a color that utilizes additional films.

In one or more implementations of the invention, to estimate the closest color film combination, the design module 142 determines the RGB values (or other color model values) of each color film, which may be represented as decimal or hexadecimal values. Then it pre-calculates the possible colors that can be created with the available resin films, and stores these possible colors within the color database 144. In various implementations, the possible colors may be created using 2, 3, 4, 5, 6, or more layers of color films.

When a custom color is received, the design module 142 converts the designer's selected color into its RGB color components. The design module 142 then accesses the color database 144 and searches against the pre-calculated colors of all possible color combinations until a match is found. In one or more implementations of the invention, the design module 142 searches for the matching film combination by adding a specific threshold number (e.g., three) to the margin of error for each of the red, blue, and green values of the customer-selected color in each iteration of search, until it finds one or more color combinations whose RGB values fall within the margins of error of the selected color.

If multiple color combinations fall within the margins of error of a selected color, the actual margin of error for each value of red, green, and blue can be averaged together to figure out which one of the matches has the average that is closest to the originally requested value. In at least one implementation, a designer is then provided with details of the color films used to make the combination (e.g., number and names of the color films), as well as the resulting color deemed to be the closest to the designer's request.

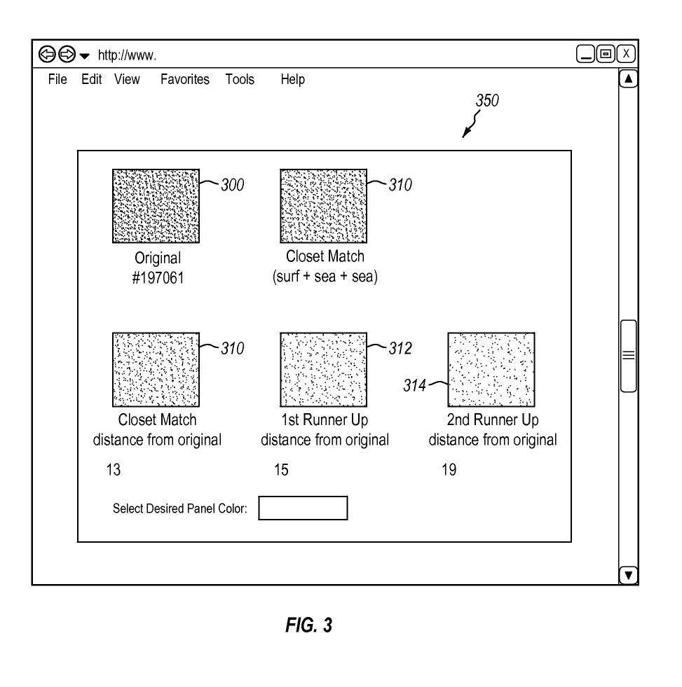

For example, FIG. 3 depicts a custom color selection interface 350 that allows a designer to pick between a group of similar custom colors. In the depicted example, the closest match 310 is produced by combining three layers of color films surf+sea+sea, which has a color distance of 13 from the original color. The first runner up 312 has a color distance of 15, and the second runner up 314 has a distance of 19 from the original color. The distance may be expressed by the averaged RGB differences, the sum of the RGB differences, or other color distance measurements. In alternative implementations, the color picker compares the colors in a device-independent color space measuring CIE color distance such as ΔE*_{ab}, ΔE*₉₄, ΔE₀₀, or ΔE*_{CMC}. Once a designer is presented with the custom color selection interface 350, the designer is free to select any of provided colors or to restart the color selection process and generate a new custom color.

For many colors, a larger number of color films tend to generate a closer match to the custom color provided by the designer. However, in searching for a match between a custom color and possible colors within a color database 144, the candidate pool of possible colors becomes increasingly large as the number of films selected for a combination increases. For example, if a manufacturer used 52 different colors of films, when only two films are combined, there are 1,326 candidate colors; when three films are combined, there are 22,100 candidate colors; when four films are combined, there are 270,725 candidate colors; when five films are combined, there are 2,598,960 candidate colors. Therefore, a search for a match between the custom color and the candidate colors can become computationally burdensome as the number of films increases.

Accordingly, in at least one implementation, the design module 142 optimizes color matching by pre-calculating the possible colors, as mentioned above. In some implementations, the design module 142 pre-calculates the possible manufacturable colors based upon the available colored films and stores these possible manufacturable colors within the color database 144. The color database 144 can also include corresponding color values from within a number of different color spaces. As the designer selects or defines a color, the design module 142 will query the color database 144 and retrieve the closest match for the designer-selected color.

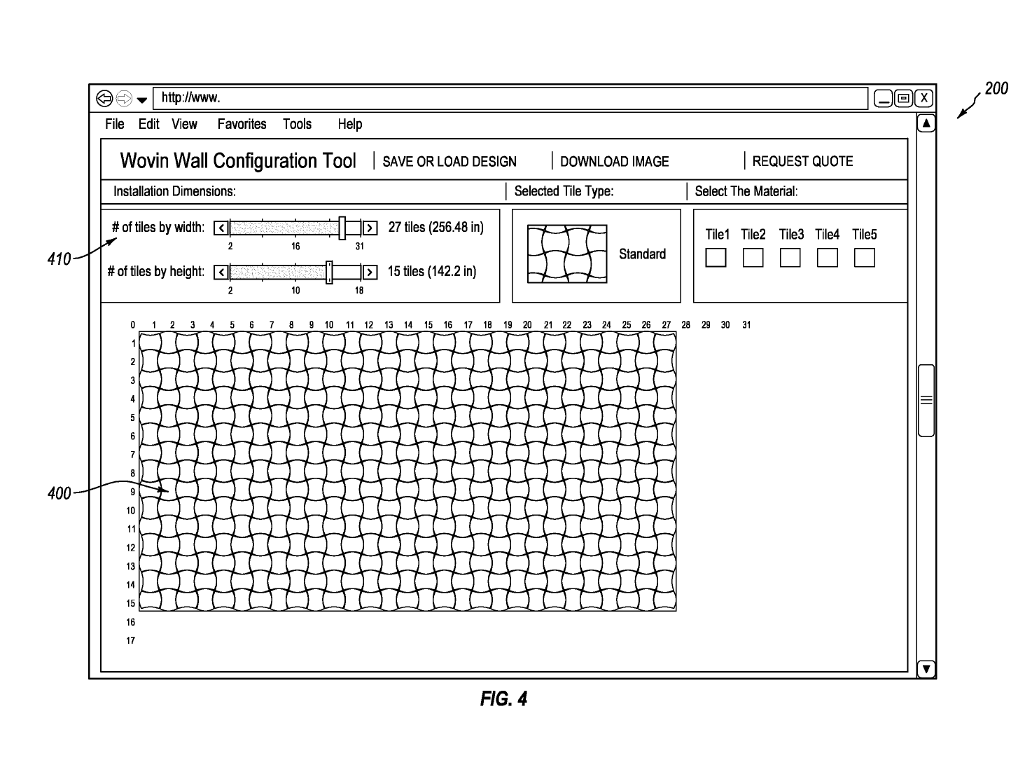

Once a designer selects a panel type and the various customizable characteristics of the panel, the I/O module 140 can display a digital depiction of the panel wall design 400 that the designer is creating. For example, FIG. 4 shows an implementation of a panel wall design interface 200 that provides a designer with tools to position, reposition and manipulate panels, add and/or change panel materials, change installation dimensions, and other related features. In particular, FIG. 4 shows a design module with a 2-D design canvas. In other implementations, panel wall design 400 can be displayed as a three-dimensional structure so that the designer can design 3-D installations and manipulate complex 3-D objects.

As shown in FIG. 4, a designer has used a size selection interface 410 to create a panel wall design 400 having twenty-one columns and eleven rows, as indicated by the grid on the design canvas. These initial dimensions of the panel wall design 400, as well as the properties of the panels, can be determined in this case by the designer's selections from the panel wall design interface 200. In at least one implementation, the designer can continue to change various characteristics of the wall panel design, including but not limited to, the color of the panels, the material of the panels, and the size of the overall design. In at least one implementation, however, if the designer wants to change the primary category of panels, the designer must start a new design.

For example, in at least one implementation, a designer can change the dimensions of the installation by dragging a handle on the width and height sliders 410. The design module 142 can automatically add or subtract rows and columns according to the respective slider, wherein the design module 142 copies panels from the closest edge column or row when adding columns or rows. The dimensions can be displayed alongside the horizontal sliders, as well as on the grid.

Once a designer is satisfied with a design, or when the designer is ready for a break from designing, the designer can save and download a design file that contains information about the wall panel design that the designer created such that the wall panel design can be recreated. Accordingly, in at least one implementation, a designer can upload a design file into the panel wall design software 130, and continue working on a previously saved panel wall design.

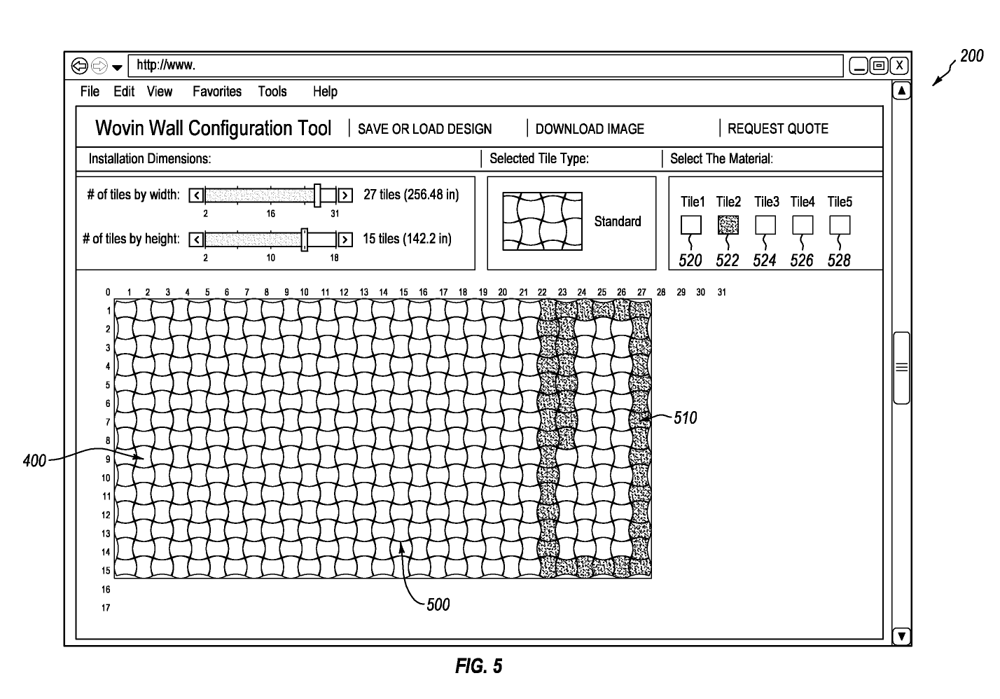

Whether working on a newly created panel wall design 400 or on a recently upload design, in at least one implementation, a designer can continue to make design changes to the panel wall design 400. For example, FIG. 5 illustrates an implementation that allows the designer to change the panel type and panel materials. In this example, the designer can select and use up to five different materials 520, 522, 524, 526, 528 in one installation. The designer selects a material by clicking or hovering over one of the five icons 520, 522, 524, 526, 528 representing five materials with customizable parameters. When the designer clicks on the panel material icon, a template pops up a window that allows the designer to select different materials represented by that icon.

In at least one implementation, when a designer selects a new panel material, the I/O module 140 can also display the various characteristic customization options that are associated with that particular panel type. For example, after selecting a new panel type a designer may be provided with a set of options to also create a new custom color for the new panel. Additionally, a designer may be able to select a previously created panel within the panel wall design 400 and change the individual panel to a different panel type, or to change a characteristic of the individual panel.

For example, in the implementation depicted in FIG. 5, a designer has selected a Wood Veneer for a second panel 522. Once the designer selects Wood Veneer as the second panel 522, a selection interface can automatically change its contents to display a sample swatch with graphical representations of different types of wood veneers available from the manufacturer, instead of color swatches as used with the first panel type. The designer can then click on one of the graphical representations of the samples to select the specific material.

After a second panel 522 is selected, a designer can draw a design in the design template using panels 510 of a particular type and/or material. After a specific panel material is chosen, the designer can apply the material by clicking the icon 522 representing that material. Then the designer can indicate locations where the panels 510 of that material should be placed on the depicted panel wall design 400. The design template may implement the indication as dragging the mouse cursor on the personal computer, or as dragging over a touch interface, or the like. The I/O 140 module then automatically draws the design onto the panel of the panel wall design 400 according to panel type, number of panels, installation dimensions, material and/or color selected by the designer.

In at least one implementation, panels must be drawn within the predefined dimensions. In an alternative implementation, the design module 142 allows the designer to draw beyond the predefined dimensions. Similarly, in at least one implementation, the design module 142 allows the designer to remove panels from a specific location by a gesture indicating removal of a panel such as the right click of a mouse or double tap of a touchscreen.

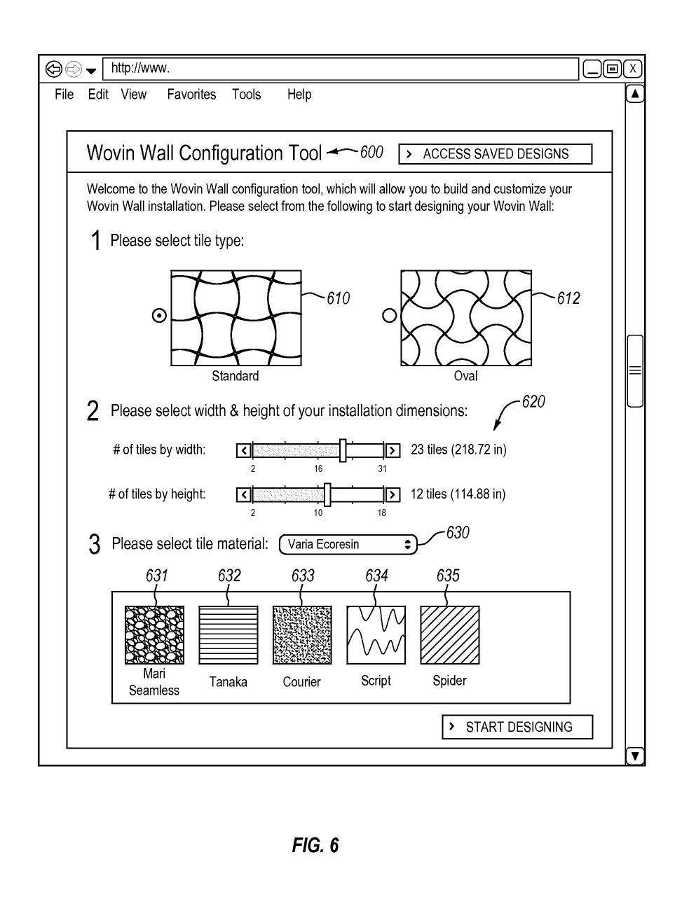

Many different types and styles of panels can be utilized within the scope of this invention. For example, FIG. 6 depicts an implementation of a wovin wall configuration tool 600, that includes a standard panel 610 and an oval panel 612, both of which are designer selectable. A wovin wall configuration tool 600 also provides a designer with an option to select a dimension 620 of a panel wall design. Additionally, a designer is able to select a panel material 630, along with an accompanying panel color or finish, in this case Mari Seamless 631, Tanaka 632, Courier 633, Script 634, or Spider 635. Once a designer selects the desired characteristics, the designer can proceed to create a panel wall design, as described above.

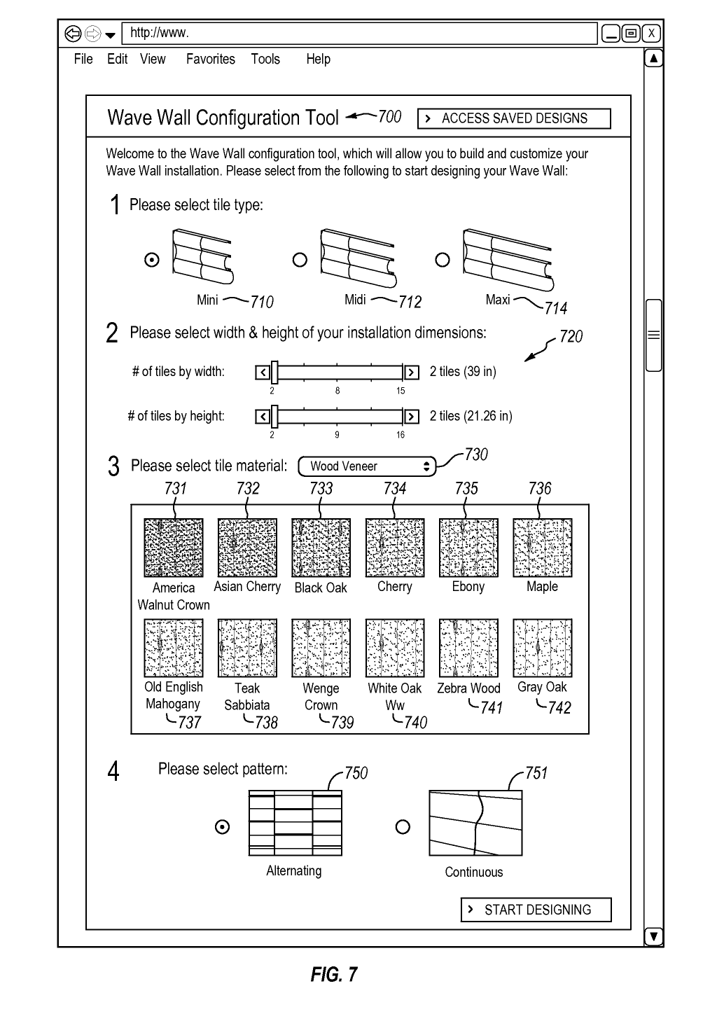

Additionally, FIG. 7 depicts an implementation of a wave wall configuration tool 700 that includes a mini panel configuration 610, a midi panel configuration 712, and a maxi panel configuration 714, both of which are designer selectable. The wave wall configuration tool 700 also provides a designer with an option to select a dimension 720 of a panel wall design. Additionally, a designer is able to select a panel material 730, along with an accompanying panel color or finish, which in this case includes a variety of different wood types 731-742. Also, the depicted implementation includes an alternating design option 750 and a continuous 751 design option. Once a designer selects the desired characteristics, the designer can proceed to create a panel wall design, as described above.

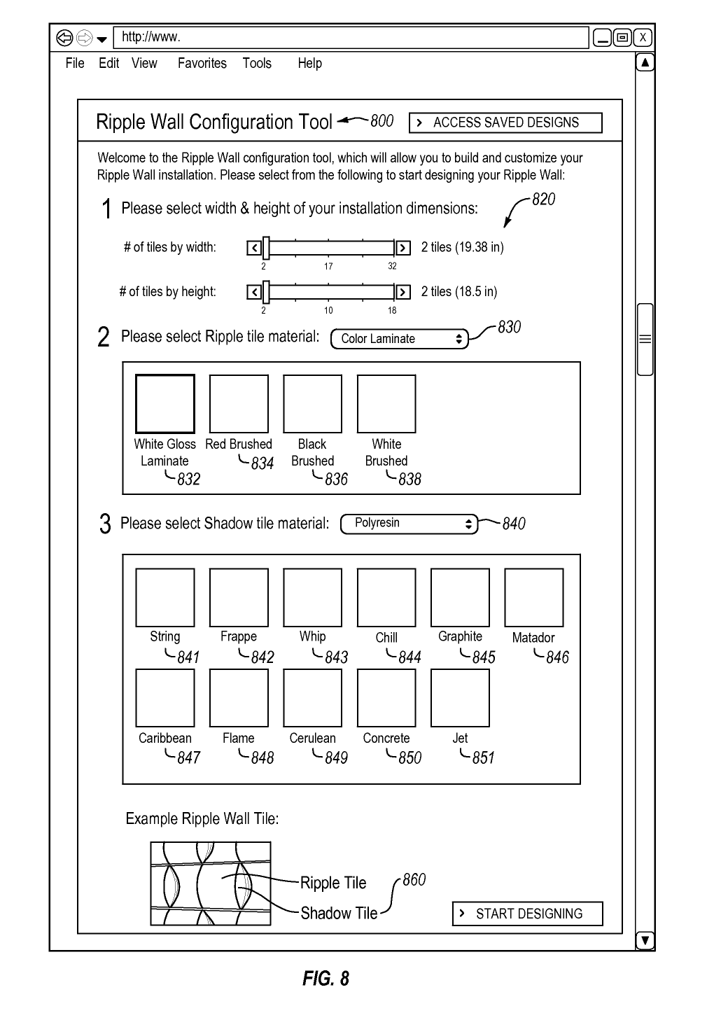

FIG. 8 depicts an implementation of a ripple wall configuration tool 800. The ripple wall configuration tool 800 provides a designer with an option to select a dimension 820 of a panel wall design. Additionally, a designer is able to select a panel material 830, along with an accompanying panel color or finish, which in this case includes a variety of finish options 832, 834, 836, and 838. After a designer selects a ripple panel type and an accompanying finish option, the designer is also able to select a material type 840 and finish 841-851 for a shadow panel 860. Once a designer selects the desired characteristics, the designer can proceed to create a panel wall design, as described above.

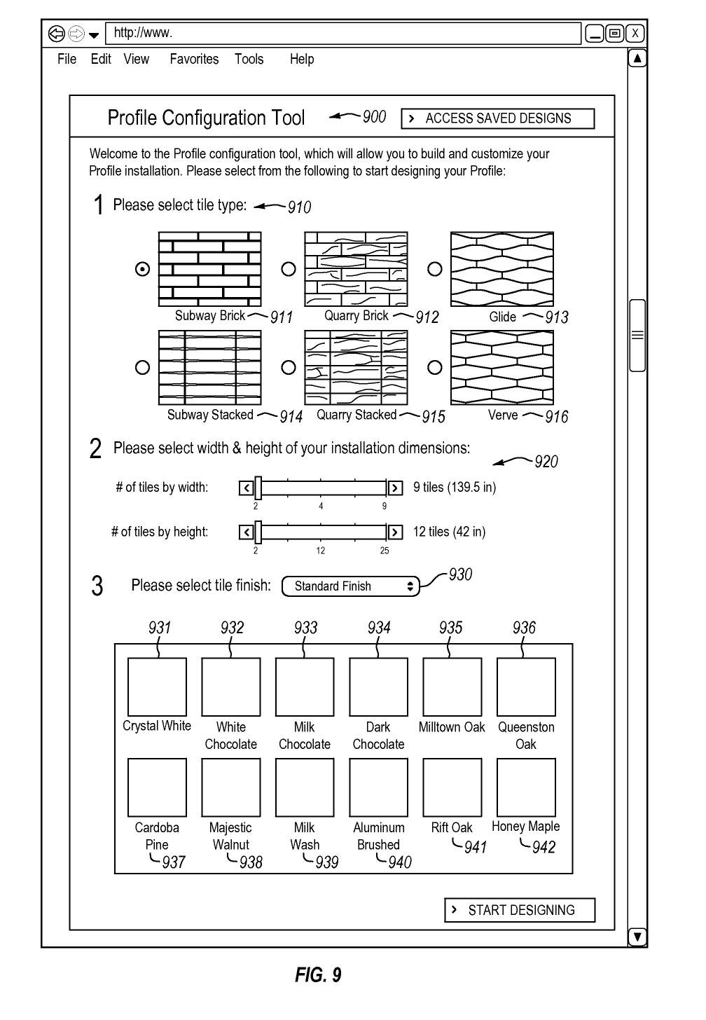

In addition, FIG. 9 depicts an implementation of a profile configuration tool 900 that includes a subway brick configuration 911, a quarry brick configuration 912, a glide configuration 913, a subway stacked configuration 914, a quarry stacked configuration 915, and a verve configuration 916, all of which are designer selectable. The profile configuration tool 900 also provides a designer with an option to select a dimension 920 of a panel wall design. Additionally, a designer is able to select a panel finish 930, which in this case includes a variety of different finish types 931-942. Once a designer selects the desired characteristics, the designer can proceed to create a panel wall design, as described above.

In at least one implementation of the present invention, due to the characteristics of materials and manufacturing processes, the cost for producing panels often increases in increments corresponding to a set number of panels. For example, it may cost $100 to produce a batch of 10 panels, such that it will cost exactly $200 for 11 to 20 panels, and $300 for 21 to 30 panels, and so on. In one or more implementations of the invention, the manufacturing module 148 and the cost module 146 provide means to guide the designer to adjust designs based on the materials and process used to produce the panels, such that the design can optimally utilize the materials and panels.

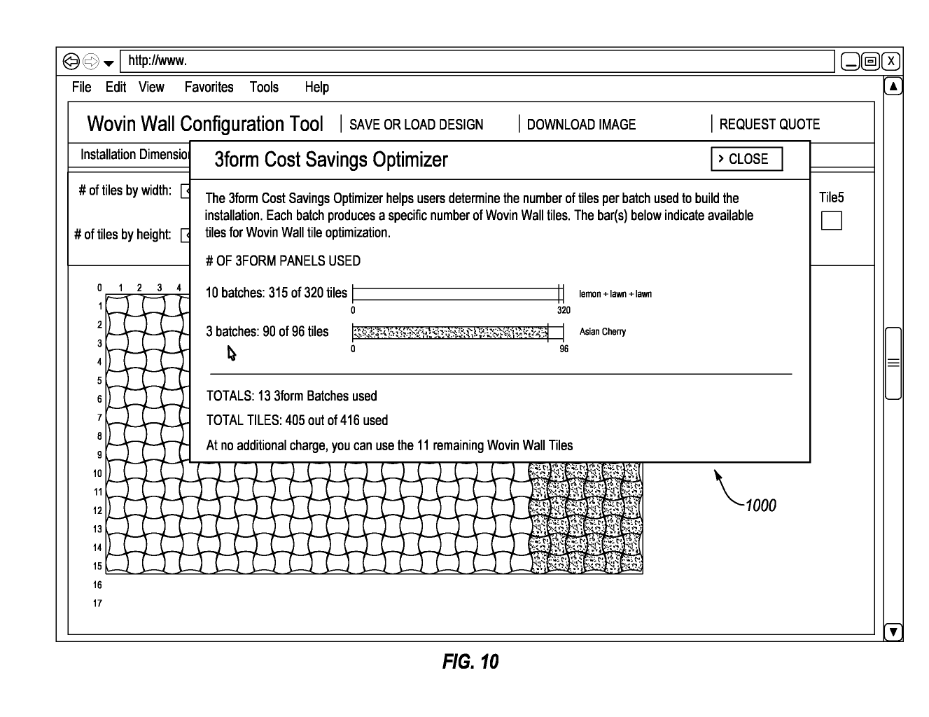

For example, the manufacturing module 148 can determine the batch sizes that would be required to manufacture the panels for a particular panel wall design. The manufacturing module 148 can then send this information to the cost module 146, which can display a cost analysis interface 1000. For example, FIG. 10 depicts an implementation of such an interface.

In particular, FIG. 10 illustrates an example of how a designer can use a cost analysis interface 1000 as a means to guide designs that avoid product waste and/or maximize use of materials. After arriving at a target design, the designer can launch the cost analysis interface shown in FIG. 10. In this example, each manufactured batch produces 32 panels. One or more horizontal bar graphs and accompanying texts indicate the number of panels used and additional panels available for no additional cost, or for a low additional cost, for each material. The designer can then use this information to guide adjustment of the design, so that the materials and panels may be utilized to the fullest extent.

Once a designer is satisfied with a particular panel wall design, the designer can request a quote for the manufacturing costs. Similar to the above disclosure, the manufacturing module 148 and the cost module 146 can together determine a quote for the costs of manufacturing. In at least one implementation, the manufacturing module 148 can also determine the current level of supplies available at a manufacturing plant, and can adjust the costs accordingly. Additionally, in at least one implementation, a quote is not automatically sent to the designer, but must first be approved or adjusted by a human designer.

Accordingly, FIGS. 1-11 and the corresponding text illustrate or otherwise describe one or more methods, systems, and/or components that can significantly aid efficiency and cost of designing and manufacturing a particular panel wall design, regardless of style or color.

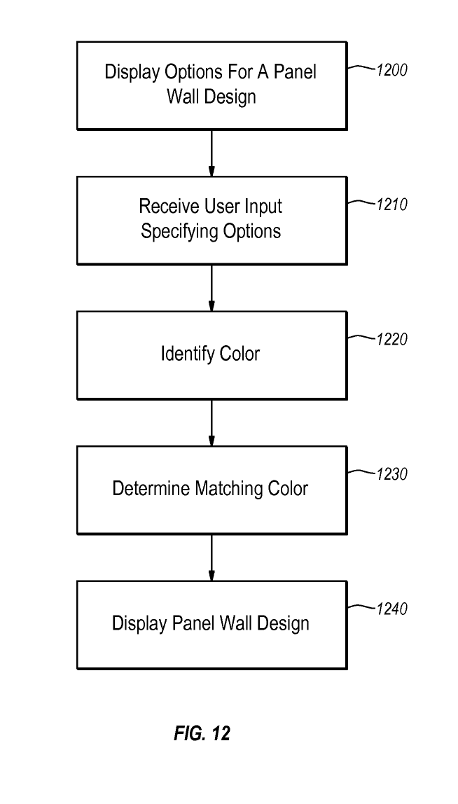

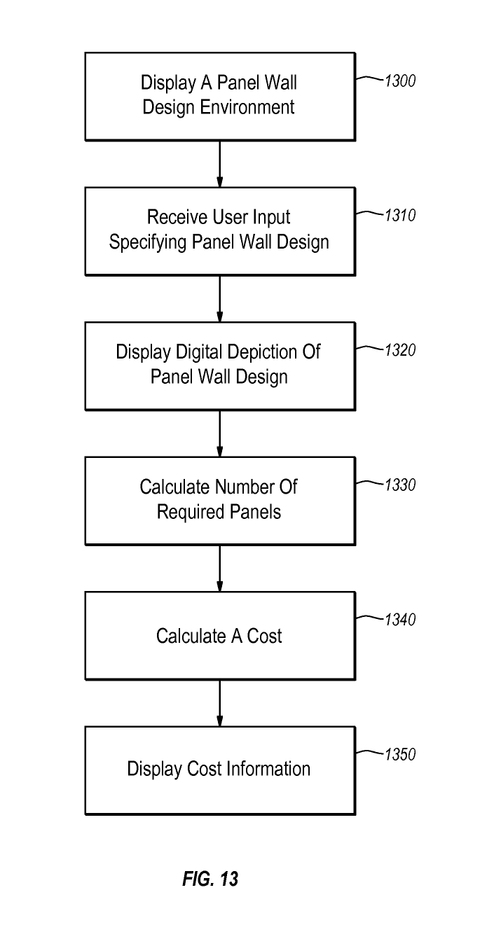

In addition to the foregoing, one will appreciate that implementations of the present invention can also be described in terms of flowcharts comprising one or more acts for accomplishing a particular result. For example, FIGS. 12 and 13 and the corresponding text described acts in a method for designing a panel wall design. The acts of FIGS. 12 and 13 are described below with respect to the components and modules of FIGS. 1-11.

For example, FIG. 12 illustrates that a method in accordance with an implementation of the present invention for creating a customized panel wall system can comprise an act 1200 of displaying options for a panel wall design. Act 1200 can include displaying on a computer monitor one or more customization options for a panel wall design, wherein the panel wall design comprises a plurality of independent panels joined together to form a wall. For example, FIG. 2 and the accompanying description depict and describe an interface displaying options for selecting a tile type, dimensions of a panel wall design, tile material, and tile color.

FIG. 12 also shows that the method can comprise an act 1210 of receiving designer input specifying options. Act 1210 can include receiving designer input specifying the one or more customization options for the panel wall design, wherein the designer input comprises a particular color for the panel wall design. For example, FIGS. 2 and 4 and the accompanying description depict and describe an implementation where a designer has selected as customization options a standard tile type and a panel wall design with dimensions of 31 by 18. FIG. 5 depicts an implementation where a panel wall design system has received further customizations from a designer directing the system to change the tile material, and thereby the color, of a select number of panels.

Additionally, FIG. 12 shows that the method can comprise an act 1220 of identifying a color. Act 1220 can include identifying the particular color selected by the designer, wherein identifying the particular color comprises determining a representation of the color within a color model. For instance, FIG. 2 and the accompanying description depict and describe an interface where a designer has selected the colors cobalt+lawn+lawn. Within the interface, a color model number 57c016 that is associated with the chosen color combination is displayed.

Further, FIG. 12 shows that the method can comprise an act 1230 of determining a matching color. Act 1230 can include determining a matching color that most closely recreates the particular color by combining together one or more colors from a pre-determined list of available discrete colors. For instance, FIG. 3 and the accompanying description depict and describe an interface where a designer is presented with a closest match color 310 that has been created with the available colors surf, sea, and sea. As described in the specification, the design system and/or the user can adjust the number of available colors that can be used to recreate the particular color.

Further still, FIG. 12 shows that the method can comprise an act 1240 of displaying a digital depiction of a panel wall design. Act 1240 can include displaying to a designer a digital depiction of the panel wall design, wherein the displayed panel wall design comprises the one or more customization options specified by the designer input. For example, FIGS. 4 and 5 depicts implementations of the panel wall design created by a designer as described above. In particular, the depicted panel wall designs include customization options that were specified by the designer.

As an additional example, FIG. 13 illustrates that a method in accordance with an implementation of the present invention for creating a customized panel wall system can comprise an act 1300 of displaying a panel wall design environment. Act 1300 can include displaying a panel wall design environment, wherein the panel wall design environment allows a designer to create and customize one or more independent panels joined together to form a panel wall design. For example, FIG. 2 and the accompanying description depict and describe a panel wall design environment that includes an options for selecting a tile type, selecting dimensions associated with a panel wall design, selecting a tile material, and selecting a tile color.

FIG. 13 also shows that the method can comprise an act 1310 of receiving designer input specifying a panel wall design. Act 1310 can include receiving designer input specifying the one or more characteristics of the panel wall design. For example, FIGS. 2 and 4 and the accompanying description depict and describe an implementation where a designer has selected as customization options a standard tile type and a panel wall design with dimensions of 31 by 18. FIG. 5 depicts an implementation where a panel wall design system has received further customizations from a designer directing the system to change the tile material, and thereby the color, of a select number of panels.

Additionally, FIG. 13 shows that the method can comprise an act 1320 of displaying a digital depiction of a panel wall design. Act 1320 can include displaying to the designer a digital depiction of the panel wall design, wherein the displayed panel wall design comprises one or more independent panels and the specified one or more characteristics. For example, FIGS. 4 and 5 depict implementations of the present invention depicting various panel wall designs to a designer. In particular, the depicted panel wall design includes individual panels and customization options that were specified by the designer.

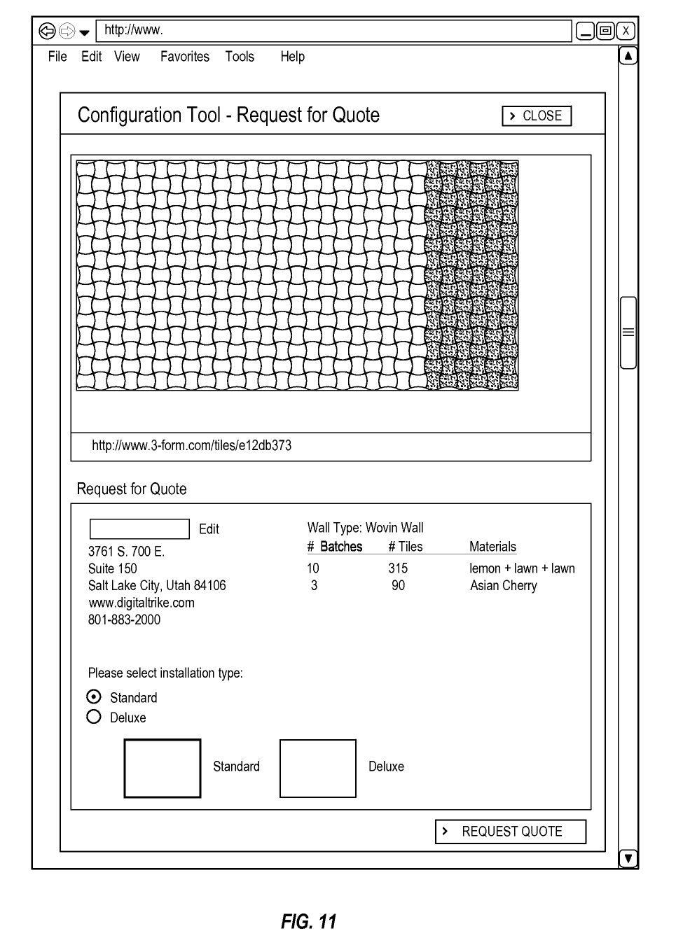

FIG. 13 also shows that the method can comprise an act 1330 of calculating a number of required panels. Act 1330 can include calculating a number of individual panels required to manufacture the displayed panel wall design. For example, FIG. 11 depicts an interface showing that manufacturing the depicted panel wall design will require 315 panels colored lemon+lawn+lemon and 90 panels that are made of Asian cherry.

Further, FIG. 13 also shows that the method can comprise an act 1340 of calculating a cost. Act 1340 can include calculating a cost associated with manufacturing the panel wall design based upon the number of individual panels and the one or more characteristics of the one or more panels, wherein the calculated cost accounts for a number of individual panels that can be created in a batch. For example, FIGS. 10 and 11 depict interfaces showing both the number of panels required to manufacture the depicted panel wall design and the number of batches required to produce the proper number of panels. Additionally, FIG. 11 depicts an interface for requesting a quote on the panel wall design.

Further still, FIG. 13 shows that the method can comprise an act 1350 of displaying cost information. Act 1350 can include displaying to the designer information relating to the cost of manufacturing the panel wall design. For example, FIGS. 10 and 11 depict interfaces showing the number of batches that will be required to create the proper number of panels. One will understand that this information includes cost information in as much as a designer can optimize the cost of the design by limiting the number of unused panels.

Accordingly, FIGS. 1-13 provide a number of components, schematics, and mechanisms for allowing a designer to create a panel wall design. At least one implementation of the present invention allows a designer to exert a great deal of control over the various aspects of design a panel wall, including, but not limited to, selecting a panel type, a panel material, a panel finish, a panel color, and other related features. Additionally, implementations of the present invention provide a designer with digital cost analysis tools that identify various methods of optimizing the cost of a particular panel wall design.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, DVD, or other optical disk storage, magnetic disk storage or other magnetic storage devices, or any other medium which can be used to store desired program code means (software) in the form of computer-executable instructions or data structures and which can be accessed by a general purpose or special purpose computer.

A “network” is defined as one or more data links that enable the transport of electronic data between computers and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer RAM and/or to less volatile computer storage media (devices) at a computer. Thus, it should be understood that computer storage media (devices) can be included in computer components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computers, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A method for allowing a designer to create a customized panel wall system, the method comprising:
displaying on a computer monitor one or more customization options for a panel wall design, wherein the panel wall design comprises a plurality of independent panels joined together to form a wall;
receiving designer input specifying the one or more customization options for the panel wall design, wherein the designer input comprises a particular color for the panel wall design;
identifying the particular color selected by the designer, wherein identifying the particular color comprises determining a representation of the color within a color model;
determining a matching color that most closely recreates the particular color by combining together one or more colors from a pre-determined list of available discrete colors; and
displaying to a designer a digital depiction of the panel wall design, wherein the displayed panel wall design comprises the one or more customization options specified by the designer input.

2. The method as recited in claim 1, wherein the pre-determined list of available discrete colors is determined based upon colors associated with color films that are layerable to create specific colors with the plurality of independent panels.

3. The method as recited in claim 2, further comprising:
receiving an indication of a number of color films that may be simultaneously combinable to create the particular color, such that the pre-determined list of available discrete colors is expandable or shrinkable based upon the number of color films that are simultaneously useable.

4. The method as recited in claim 2, wherein the pre-determined list of available discrete colors is pre-calculated by determining the colors that are created by layering the color films in a plurality of different combinations.

5. The method as recited in claim 1, further comprising:
displaying to the designer one or more possible colors, wherein the one or more possible colors include the matching color that most closely recreates the particular color along with one or more additional runner-up colors that to a lesser extent recreate the particular color;
receiving an indication from the designer selecting one of the one or more possible colors; and
incorporating the selected color into the digital depiction of the panel wall design.

6. The method as recited in claim 5, further comprising:
displaying to the designer a price associated with each of the one or more possible colors, wherein the price of the one or more possible colors is determined, at least in part, by the number of color films used to create each of the one or more possible colors.

7. The method as recited in claim 5, further comprising:
receiving from the designer a limit to the number of color films that can be used to create the one or more possible colors; and
displaying to the designer only colors that fall within the limit received from the designer.

8. The method as recited in claim 1, further comprising:
calculating a number of individual panels required to manufacture the displayed panel wall design;
calculating a cost associated with manufacturing the panel wall design based upon the number of individual panels and the one or more customization options, wherein the individual panels are manufactured in batches that comprise a set number of individual panels such that a cost associated with manufacturing the panel wall design is influenced by a number of batches manufactured even if the panel wall design does not utilize every individual panel manufactured by the number of batches; and
displaying to the designer information relating to the cost of manufacturing the panel wall design.

9. The system as recited in claim 8, further comprising:
displaying to the designer a number of unused individual panels that will be manufactured as part of a batch but not used to create the panel wall design; and
receiving a direction from the designer to incorporate one or more of the unused individual panels into the panel wall design.

10. At a computerized system in a computerized panel wall design environment in which a design program is loaded in memory and processed at a central processing unit, a computer program storage product having computer-executable instructions stored thereon that, when executed, caused one or more processors of the computerized system to perform a method for allowing a designer to create a customized panel wall system, the method comprising:
displaying a panel wall design environment, wherein the panel wall design environment allows a designer to create and customize one or more independent panels joined together to form a panel wall design;
receiving a designer input specifying one or more characteristics of the panel wall design;
displaying to the designer a digital depiction of the panel wall design, wherein the displayed panel wall design comprises one or more independent panels and the specified one or more characteristics;
calculating a number of individual panels required to manufacture the displayed panel wall design;
calculating a cost associated with manufacturing the panel wall design based upon the number of individual panels and the one or more characteristics of the one or more panels, wherein the calculated cost accounts for a number of individual panels that can be created in a batch; and
displaying to the designer information relating to the cost of manufacturing the panel wall design.

11. The system as recited in claim 10, further comprising:
receiving a designer input changing a panel characteristic of an individual panel of the one or more independent panels; and
updating the digital depictions of the panel wall design to include a depiction of the individual panel comprising the specified one or more characteristics and the changed panel characteristic of the individual panel.

12. The system as recited in claim 10, wherein the individual panels are manufactured in batches that comprise a set number of individual panels such that a customer is charged for a number of batches manufactured even if the panel wall design does not utilize every individual panel manufactured by the number of batches.

13. The system as recited in claim 12, further comprising:
displaying to the designer a number of unused individual panels that will be manufactured as part of a batch but not used to create the panel wall design.

14. The system as recited in claim 13, further comprising:
displaying to the designer an option to incorporate the unused individual panels into the panel wall design; and
receiving a direction from the designer to incorporate one or more of the unused individual panels into the panel wall design.

15. The method as recited in claim 10, wherein at least one of the specified one or more characteristics of the panel wall design comprises a color option that allows the designer to select a particular color to apply to at least one panel within the panel wall design.

16. The method as recited in claim 15, further comprising:
identifying the particular color selected by the designer, wherein identifying the particular color comprises determining a representation of the color within a color model; and
determining a matching color that most closely recreates the particular color by combining together one or more colors from a pre-determined list of available discrete colors.

17. The method as recited in claim 16, wherein the pre-determined list of available discrete colors is determined based upon colors associated with color films that are layerable to create the colors that are associated with the plurality of independent panels.

18. The method as recited in claim 17, further comprising:
receiving an indication of the number of color films that may be simultaneously combinable to create the particular color, such that the pre-determined list of available discrete colors is expandable or shrinkable based upon the number of color films that are simultaneously useable.

19. The method as recited in claim 16, further comprising:
displaying to the designer one or more possible colors, wherein the one or more possible colors include the matching color that most closely recreates the particular color along with one or more additional runner-up colors that to a lesser extent recreate the particular color;
receiving an indication from the designer selecting one of the one or more possible colors; and
incorporating the selected color into the digital depiction of the panel wall design.

20. In a computing environment one or more physical storage media comprising computer executable instructions that when executed by one or more processors causes the one or more processors to perform the following:
displaying on a computer monitor one or more customization options for a panel wall design, wherein the panel wall design comprises a plurality of independent panels joined together to form a wall;
receiving designer input specifying the one or more customization options for the panel wall design, wherein the designer input comprises a particular color for the panel wall design;
identifying the particular color selected by the designer, wherein identifying the particular color comprises determining a representation of the color within a color model;
determining a matching color that most closely recreates the particular color by combining together one or more colors from a pre-determined list of available discrete colors; and
displaying to a designer a digital depiction of the panel wall design, wherein the displayed panel wall design comprises the one or more customization options specified by the designer input.
